(19) United States
(12) Patent Application Publication
(10) Pub. No.: US 2023/0406136 A1
(43) Pub. Date: Dec. 21, 2023

(54) Detection Circuit, Anti-Backflow System, and Charging Pile

(71) Applicant: Huawei Digital Power Technologies Co., Ltd., Shenzhen (CN)

(72) Inventors: Zhenting Jiang, Dongguan (CN); Jiansheng Chen, Shenzhen (CN); Yaping Liu, Shenzhen (CN); Jianhui Xiong, Shenzhen (CN)

(21) Appl. No.: 18/460,026

(22) Filed: Sep. 1, 2023

Related U.S. Application Data
(63) Continuation of application No. PCT/CN2021/079123, filed on Mar. 4, 2021.

(51) Int. Cl. B60L 53/62; H02J 7/00

(52) U.S. Cl. CPC B60L 53/62; H02J 7/0029; B60L 2210/30

(57) ABSTRACT

A detection circuit includes a detection power supply and a digital unit that are connected in series. A first end and a second end of the detection circuit are respectively connected to an input end and an output end of an anti-backflow circuit. The detection power supply may make an electric potential at the second end of the detection circuit higher than that at the first end of the detection circuit. When transmitting a detection current, the digital unit may output a first level signal indicating that the anti-backflow circuit fails. The detection current is a current transmitted when a loop is formed between the first end and the second end of the detection circuit.

### CROSS-REFERENCE TO RELATED APPLICATIONS

This is a continuation of International Patent Application No. PCT/CN2021/079123 filed on Mar. 4, 2021, which is hereby incorporated by reference in its entirety.

### TECHNICAL FIELD

This disclosure relates to the technical field of electric vehicles, and in particular, to a detection circuit, an anti-backflow system, and a charging pile.

### BACKGROUND

With popularization of electric vehicles, people have an increasingly high requirement on a charging speed of an electric vehicle. To meet a requirement for fast charging of an electric vehicle, an increasingly large quantity of electric vehicles is provided with high-voltage battery packs as power batteries. During charging of an electric vehicle, the electric vehicle may be electrically connected to a charging pile, and a high-voltage battery pack in the electric vehicle may receive and store electric energy provided by the charging pile.

However, with popularization of high-voltage battery packs in electric vehicles, a battery voltage of a high-voltage battery pack may be higher than an output voltage of a charging pile. Therefore, in a charging process of an electric vehicle, a power battery (a high-voltage battery pack) in the electric vehicle may output electric energy to a charging pile (that is, backflow). This may cause damage to a safety device in the electric vehicle. In view of this, the charging pile needs to be provided with an anti-backflow circuit. The anti-backflow circuit is a unidirectional transmission circuit. An output end of the anti-backflow circuit can only be used to output electric energy to an output interface of the charging pile, and electric energy cannot be received from an output interface of the anti-backflow circuit. Therefore, the anti-backflow circuit can prevent the power battery from outputting electric energy to the charging pile.

Because the anti-backflow circuit is related to charging safety of the electric vehicle, the charging pile needs to stop outputting electric energy in time when the anti-backflow circuit fails. However, accuracy of other technologies for failure detection of an anti-backflow circuit is relatively low, and the technology for failure detection of an anti-backflow circuit needs to be further studied.

### SUMMARY

This disclosure provides a detection circuit, an anti-backflow system, and a charging pile, to improve accuracy of failure detection of an anti-backflow circuit.

According to a first aspect, this disclosure provides a detection circuit. The detection circuit may perform failure detection on an anti-backflow circuit. A first end of the detection circuit may be connected to a high-electric-potential input end of the anti-backflow circuit, and a second end of the detection circuit may be connected to a high-electric-potential output end of the anti-backflow circuit. The detection circuit provided in this disclosure mainly includes a detection power supply and a digital unit, and the detection power supply and the digital unit are connected in series between the first end of the detection circuit and the second end of the detection circuit. The detection power supply may apply bias voltages to the first end and the second end of the detection circuit to make an electric potential at the second end of the detection circuit higher than that at the first end of the detection circuit. The digital unit may output a first level signal when transmitting a detection current, where the first level signal may indicate that the anti-backflow circuit fails, and the detection current is a current transmitted between the first end and the second end of the detection circuit when a current loop is formed between the first end and the second end of the detection circuit.

In this disclosure, the first level signal is generated based on the detection current. The detection circuit only needs to distinguish whether there is a detection current, and does not need to further detect the detection current. Therefore, a detection result of the detection circuit provided in this disclosure may not depend on detection precision of a voltage value. This helps improve accuracy of failure detection of the anti-backflow circuit. In addition, the detection circuit provided in this disclosure does not depend on an input voltage and an output voltage of the anti-backflow circuit to perform detection. Therefore, the detection circuit may perform failure detection before a charging pile is connected to a power battery. This further helps protect safety of an electric vehicle.

Corresponding to the first level signal, the digital unit may further output a second level signal when the digital unit does not transmit a detection current, where the second level signal may indicate that the anti-backflow circuit does not fail. For example, if the first level signal is a high-level signal, the second level signal is a low-level signal. For another example, if the first level signal is a low-level signal, the second level signal is a high-level signal. In other words, the digital unit may output a digital signal. When the digital signal is at a first level, it may indicate that the anti-backflow circuit fails; and when the digital signal is at a second level, it may indicate that the anti-backflow circuit does not fail.

For example, the digital unit includes a current input end, a current output end, and a signal output end; a positive electrode of the detection power supply is connected to the current input end of the digital unit, and a negative electrode of the detection power supply is connected to the first end of the detection circuit; the current output end of the digital unit is connected to the second end of the detection circuit; and the signal output end of the digital unit may output the first level signal.

It should be understood that, another possible structure may alternatively be connected in series between the digital unit and the detection unit. This is not limited in embodiments of this disclosure.

To prolong a service life of the detection circuit, in a possible implementation, the detection circuit may further include a breaking circuit, and the breaking circuit is connected in series to both the detection power supply and the digital unit. The breaking circuit may be connected during failure detection of the anti-backflow circuit, and may be disconnected when the failure detection ends.

For example, the breaking circuit may be located between the detection power supply and the digital unit, one end of the breaking circuit is connected to the detection power supply, and the other end of the breaking circuit is connected to the digital unit. It may be understood that, another possible structure may alternatively be connected in series between two of the breaking circuit, the detection power supply, and the digital unit. These are not listed in embodiments of this disclosure one by one.

In this embodiment of this disclosure, the breaking circuit may be connected during failure detection of the anti-backflow circuit, so that a current loop can be formed between the first end and the second end of the detection circuit when the anti-backflow circuit fails. The breaking circuit may also be disconnected after failure detection of the anti-backflow circuit ends. This helps prolong the service life of the detection circuit.

To protect the detection circuit, in a possible implementation, the detection circuit may further include a detection diode, and the detection diode is connected in series to both the detection power supply and the digital unit. An anode of the detection diode may receive the detection current, and a cathode of the detection diode may output the detection current. In other words, the detection diode does not block transmission of the detection current. However, during backflow of a power battery to the detection circuit, when no detection diode is disposed, a backflow current is input from the second end of the detection circuit, and is output from the first end of the detection circuit. Therefore, in this disclosure, the detection diode may be disposed to block transmission of the backflow current in the detection circuit. This helps prevent backflow of the power battery to the detection circuit.

To protect the digital unit, in a possible implementation, the detection circuit may further include a detection resistor, and the detection resistor is connected in series to both the detection power supply and the digital unit. The detection resistor may be disposed to perform current limiting on the detection current. This helps prevent the digital unit from being damaged due to an excessively large detection current.

In this disclosure, the digital unit may use an isolation structure to enhance anti-electromagnetic interference (anti-EMI) performance. The digital unit includes a primary-side circuit and a secondary-side circuit, and the secondary-side circuit and the primary-side circuit are isolated from each other. The primary-side circuit may transmit the detection current, and the secondary-side circuit may output the first level signal when the primary-side circuit transmits the detection current.

The input end of the anti-backflow circuit is usually connected to an electromagnetic interference (EMI) filter circuit. The EMI filter circuit may filter out EMI in direct current electric power, to reduce EMI in direct current electric power output by the anti-backflow circuit. However, in this disclosure, because the second end of the detection circuit is connected to the output end of the anti-backflow circuit, some EMI may bypass the EMI filter circuit by using the digital unit, to be directly output from the output end of the anti-backflow circuit. In view of this, the digital unit in this disclosure may use an isolation structure to block a path used for transmitting EMI to the anti-backflow circuit. This helps reduce the EMI in the direct current electric power output by the anti-backflow circuit, and enhances anti-EMI performance.

For example, although the primary-side circuit and the secondary-side circuit are isolated from each other, coupling in a form of an energy field, for example, optical coupling, magnetic coupling, or electric field coupling, may be implemented between the primary-side circuit and the secondary-side circuit. When the detection current passes through the primary-side circuit, the secondary-side circuit may sense an energy change in the primary-side circuit by using an energy field, to generate the first level signal.

Using optical coupling as an example, the primary-side circuit includes a light-emitting diode, an anode of the light-emitting diode may receive the detection current, a cathode of the light-emitting diode may output the detection current, and the light-emitting diode may emit light when transmitting the detection current; and the secondary-side circuit may include a light-sensing switching transistor, and the light-sensing switching transistor may be turned on when the light-emitting diode emits light, so that the secondary-side circuit outputs the first level signal.

Generally, a signal acquisition circuit may output an acquired signal to a control circuit, and the control circuit further processes the signal acquired by the signal acquisition circuit. The control circuit is a digital circuit, and may process a digital signal. However, a level signal output by the digital unit may be difficult to be identified by the control circuit due to an irregular waveform. In view of this, the detection circuit may further include a signal acquisition circuit. The signal acquisition circuit may perform shaping filtering on the first level signal output by the digital unit. After shaping filtering is performed, a waveform of a digital signal output by the digital unit is more regular, so that the control circuit can identify the first level signal more accurately.

According to a second aspect, this disclosure provides an anti-backflow system. The anti-backflow system mainly includes an anti-backflow circuit and the detection circuit provided in any implementation of the first aspect. A first end of the detection circuit is connected to a high-electric-potential input end of the anti-backflow circuit, and a second end of the detection circuit is connected to a high-electric-potential output end of the anti-backflow circuit.

According to a third aspect, this disclosure provides a charging pile. The charging pile mainly includes a conversion circuit and the anti-backflow system provided in the second aspect. The conversion circuit may convert received alternating current electric power into direct current electric power, and output the converted direct current electric power to an anti-backflow circuit. Then, the anti-backflow circuit may output the direct current electric power. For example, the direct current electric power may be output to an electric vehicle as charging electric energy, so that the electric vehicle can be charged.

In a possible implementation, the charging pile may further include a control circuit. The control circuit is connected to both the conversion circuit and a digital unit. After receiving a first level signal output by the digital unit, the control circuit may prohibit the conversion circuit from outputting direct current electric power to the anti-backflow circuit. This helps prevent backflow of a power battery in the electric vehicle.

These aspects or other aspects of this disclosure are more readily apparent from the following description of embodiments.

### BRIEF DESCRIPTION OF DRAWINGS

FIG. 1 is a schematic diagram of a charging system.

FIG. 2 is a schematic diagram of a structure of a charging module.

FIG. 3 is a schematic diagram of a failure detection architecture of an anti-backflow circuit.

FIG. 4 is a schematic diagram of a structure of a detection circuit according to an embodiment of this disclosure.

FIG. 5 is a schematic diagram of a specific structure of a detection circuit according to an embodiment of this disclosure.

FIG. 6A and FIG. 6B are schematic diagrams of circuit statuses of a detection circuit when an anti-backflow circuit does not fail according to an embodiment of this disclosure.

FIG. 7A and FIG. 7B are schematic diagrams of circuit statuses of a detection circuit when an anti-backflow circuit fails according to an embodiment of this disclosure.

FIG. 8 is a schematic diagram of a structure of an isolation unit according to an embodiment of this disclosure.

### DESCRIPTION OF EMBODIMENTS

To make the objectives, technical solutions, and advantages of this disclosure clearer, the following further describes this disclosure in detail with reference to the accompanying drawings. A specific operation method in a method embodiment may also be applied to an apparatus embodiment or a system embodiment. It should be noted that in description of this disclosure, “at least one” means one or more, and “a plurality of” means two or more. In view of this, in embodiments of the present disclosure, “a plurality of” may also be understood as “at least two”. The term “and/or” describes an association relationship for describing associated objects and represents that three relationships may exist. For example, A and/or B may represent the following three cases: only A exists, both A and B exist, and only B exists. In addition, the character “/” generally indicates an “or” relationship between the associated objects. In addition, it should be understood that in description of this disclosure, terms such as “first” and “second” are merely used for distinguishing and description, but should not be understood as indicating or implying relative importance, or should not be understood as indicating or implying a sequence.

It should be noted that the “connection” in embodiments of this disclosure may be understood as an electric connection, and a connection between two electrical elements may be a direct or indirect connection between the two electrical elements. For example, a connection between A and B may represent that A and B are directly connected to each other, or A and B are indirectly connected to each other by using one or more other electrical elements. For example, the connection between A and B may also represent that A is directly connected to C, C is directly connected to B, and A and B are connected to each other through C.

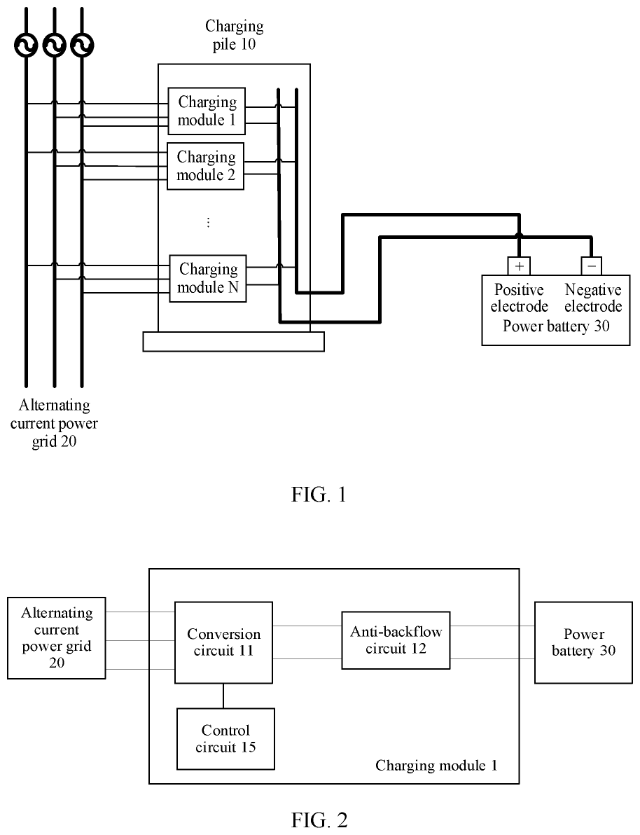

Currently, an electric vehicle is charged by mainly depending on a charging pile. FIG. 1 is a schematic diagram of an example of a charging system in which a charging pile charges a power battery. As shown in FIG. 1, a charging pile 10 is connected to both an alternating current power grid 20 and a power battery 30. The alternating current power grid 20 may provide alternating current electric power to the charging pile 10, and the charging pile 10 may convert the received alternating current electric power, and provide converted electric energy to the power battery 30. The power battery 30 receives and stores the electric energy provided by the charging pile 10, to implement charging.

In FIG. 1, the power battery 30 may be disposed in an electric vehicle to provide energy to the electric vehicle, so that the electric vehicle works. To meet a requirement for fast charging of the electric vehicle, the charging pile 10 may provide a high-power direct current to the power battery 30 for charging. To be specific, the charging pile 10 may receive the alternating current electric power provided by the alternating current power grid 20, convert the alternating current electric power into direct current electric power, and output the direct current electric power to the power battery 30; and power of the direct current electric power is relatively high.

As shown in FIG. 1, the charging pile 10 may include N charging modules (a charging module 1, a charging module 2, . . . , and a charging module N), where N is an integer greater than or equal to 1. The N charging modules are connected in parallel between the alternating current power grid 20 and the power battery 30, and each charging module may receive alternating current electric power from the alternating current power grid 20, convert the alternating current electric power into direct current electric power, and provide the converted direct current electric power to the power battery 30. In this case, a total output power of the charging pile 10 may be a sum of output powers of the N charging modules.

For example, currently, the total output power of the charging pile 10 mainly includes three types: 60 kilowatts (kW), 90 kW, and 120 kW. Assuming that an output power of each charging module is 15 watts (W), quantities of charging modules in the charging pile 10 are correspondingly 4, 6, and 8.

Because an increasingly large quantity of power batteries 30 use high-voltage battery packs, the power batteries 30 have relatively high battery voltages. When a battery voltage of the power battery 30 exceeds an output voltage of the charging pile 10, the power battery 30 may output battery electric energy to the charging pile 10. This process may also be referred to as backflow of the power battery 30. During backflow of the power battery 30, a safety device (for example, a contactor or a safety wire that is in the electric vehicle and that is used to protect the power battery 30) in the electric vehicle may fail.

In addition, in the industry standard “NB/T 33001-2010 Specification for electric vehicle off-board conductive charger”, the charging pile 10 is also required to have an anti-backflow function. In view of this, an anti-backflow circuit further needs to be disposed in each charging module to prevent backflow of the power battery 30.

The charging module 1 is used as an example. For example, as shown in FIG. 2, the charging module 1 mainly includes a conversion circuit 11 and an anti-backflow circuit 12. An input end of the conversion circuit 11 is connected to the alternating current power grid 20, an output end of the conversion circuit 11 is connected to the anti-backflow circuit 12, and an output end of the anti-backflow circuit 12 is connected to the power battery 30.

The conversion circuit 11 includes an alternating current-direct current conversion circuit. During charging of the power battery 30, the conversion circuit 11 may receive alternating current electric power provided by the alternating current power grid 20, convert the alternating current electric power into direct current electric power, and output the direct current electric power to the power battery 30 through the anti-backflow circuit 12.

It should be noted that the conversion circuit 11 may include a circuit with another function. For example, the conversion circuit 11 may further include a direct current-direct current conversion circuit. The direct current-direct current conversion circuit may be connected to an output end of the alternating current-direct current conversion circuit, so that the direct current-direct current conversion circuit can further perform voltage regulation on the direct current electric power output by the alternating current-direct current conversion circuit. For another example, the conversion circuit 11 may further include an EMI filter circuit. The EMI filter circuit may filter out EMI in the direct current electric power obtained by the conversion circuit 11 through conversion, and the like. These are not listed in embodiments of this disclosure one by one.

The anti-backflow circuit 12 is a circuit with a unidirectional transmission function, and may be a diode or a functional circuit that can be equivalent to a diode. A diode is used as an example. An anode of the diode is connected to the conversion circuit 11, and a cathode of the diode is connected to the power battery 30. In the charging module 1 shown in FIG. 2, electric energy can be transmitted only from an input end of the anti-backflow circuit 12 (an end close to the conversion circuit 11) to an output end of the anti-backflow circuit 12 (an end close to the power battery 30).

In other words, a current can be transmitted only from a high-electric-potential output end of the conversion circuit 11 to a high-electric-potential input end of the anti-backflow circuit 12, and flows back from a low-electric-potential input end of the anti-backflow circuit 12 to a low-electric-potential output end of the conversion circuit 11. The current cannot be transmitted from the high-electric-potential input end of the anti-backflow circuit 12 to the high-electric-potential output end of the conversion circuit 11, and cannot flow back from the low-electric-potential output end of the conversion circuit 11 to a low-electric-potential input end of the conversion circuit 11 either.

Therefore, when the battery voltage of the power battery 30 exceeds an output voltage of the charging module 1, the anti-backflow circuit 12 stops the power battery 30 from discharging the charging module 1, to implement an anti-backflow function.

In conclusion, the anti-backflow circuit 12 is an important structure of a charging pile 20. When the anti-backflow circuit 12 fails, charging safety of the electric vehicle is threatened. Therefore, failure detection of the anti-backflow circuit 12 has become particularly important. That the anti-backflow circuit 12 fails may be understood as that the anti-backflow circuit 12 loses a unidirectional transmission function and electric energy may be transmitted from the output end of the anti-backflow circuit 12 to the input end of the anti-backflow circuit 12.

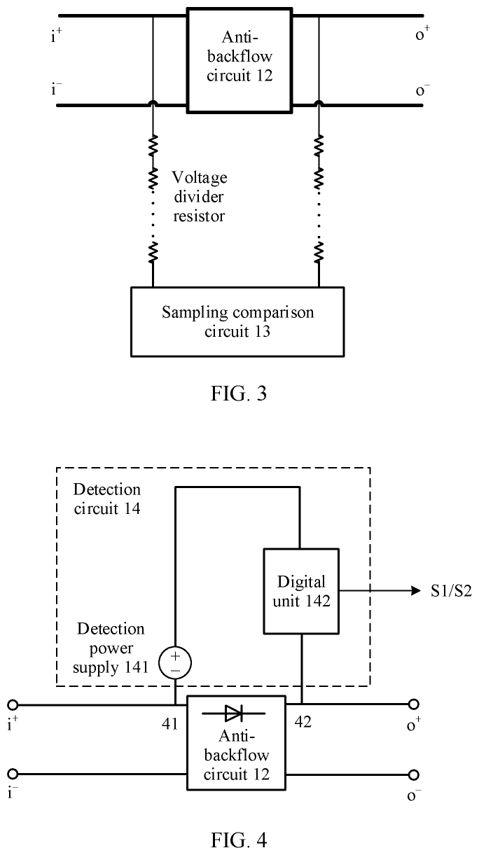

Currently, an architecture shown in FIG. 3 is usually used to perform failure detection on the anti-backflow circuit 12. As shown in FIG. 3, the charging module 1 may further include a sampling comparison circuit 13 and a plurality of voltage divider resistors. Some voltage divider resistors are connected in series between a high-electric-potential input end i⁺ of the anti-backflow circuit 12 and a first end of the sampling comparison circuit 13, and the other voltage divider resistors are connected in series between a high-electric-potential output end o⁺ of the anti-backflow circuit 12 and a second end of the sampling comparison circuit 13.

Quantities of the two parts of voltage divider resistors are the same, so that electric potentials at the first end and the second end of the sampling comparison circuit 13 can be reduced proportionally. This helps protect safety of the sampling comparison circuit 13. In addition, a relative electric potential between the first end and the second end can keep consistent with a relative electric potential between the high-electric-potential input end i⁺ and the high-electric-potential output end o⁺.

The sampling comparison circuit 13 determines, based on an electric potential difference between the first end and the second end, whether the anti-backflow circuit 12 fails. If a difference obtained by subtracting the electric potential at the second end from the electric potential at the first end is greater than or equal to a comparison threshold, it indicates that electric energy is transmitted from the input end of the anti-backflow circuit 12 to the output end of the anti-backflow circuit 12 in this case and the anti-backflow circuit 12 does not fail. If the difference obtained by subtracting the electric potential at the second end from the electric potential at the first end is less than the comparison threshold, it indicates that the anti-backflow circuit 12 fails in this case.

However, because the output voltage of the charging module 1 is relatively high, and currently a maximum voltage may reach approximately 1000 volts (V), electric potentials at the high-electric-potential input end i⁺ and the high-electric-potential output end o⁺ of the anti-backflow circuit 12 are relatively high. The first end and the second end of the sampling comparison circuit 13 need to be connected in series to a relatively large quantity of voltage divider resistors to reduce the electric potentials at the first end and the second end. In addition, because a voltage drop of the anti-backflow circuit 12 is relatively small, that is, a voltage between the high-electric-potential input end i⁺ and the high-electric-potential output end o⁺ is relatively small, when a relatively large quantity of voltage divider resistors are connected in series, sampling precision of the sampling comparison circuit 13 is reduced.

For example, the electric potential at the high-electric-potential input end i⁺ is 1000 V, and the electric potential at the high-electric-potential output end o⁺ is 998 V. After the voltage divider resistors perform voltage division, the electric potential at the first end of the sampling comparison circuit 13 is 10 V, and the electric potential at the second end of the sampling comparison circuit 13 is 9.98 V. In this case, the electric potential difference between the first end and the second end is only 0.02 V. If a sampling error of the sampling comparison circuit 13 is greater than 0.02 V, the sampling comparison circuit 13 cannot accurately identify whether the anti-backflow circuit 12 fails.

In addition, in the failure detection solution shown in FIG. 3, failure detection of the anti-backflow circuit 12 can be performed only after electric energy starts to be transmitted between the conversion circuit 11 and the power battery 30, in other words, failure detection of the anti-backflow circuit 12 can be performed only after the charging pile 20 starts charging the power battery 30. If the anti-backflow circuit 12 has failed before the charging pile 20 is connected to the power battery 30, a backflow risk of the power battery 30 may occur when the failure detection solution shown in FIG. 3 is used.

In view of this, an embodiment of this disclosure provides a detection circuit. The detection circuit may perform failure detection on an anti-backflow circuit 12. This helps improve accuracy of failure detection. In addition, when a charging pile 20 is not connected to a power battery 30, the detection circuit provided in this embodiment of this disclosure may also perform failure detection on an anti-backflow circuit 12. This helps reduce a backflow risk of the power battery 30.

For example, the detection circuit provided in this embodiment of this disclosure may be shown in FIG. 4. A first end 41 of the detection circuit 14 is connected to a high-electric-potential input end i⁺ of an anti-backflow circuit, a second end 42 of the detection circuit 14 is connected to a high-electric-potential output end o⁺ of the anti-backflow circuit 12, and the detection circuit 14 may perform failure detection on the anti-backflow circuit 12.

The detection circuit 14 includes a detection power supply 141 and a digital unit 142, and the detection power supply 141 and the digital unit 142 are connected in series between the first end 41 and the second end 42 of the detection circuit 14. The detection power supply 141 is a direct current power supply, and may apply bias voltages to the first end 41 and the second end 42 of the detection circuit 14 to make an electric potential at the second end 42 of the detection circuit 14 higher than that at the first end 41 of the detection circuit 14.

In other words, a negative electrode of the detection power supply 141 is disposed close to the first end 14, and a positive electrode of the detection power supply 141 is disposed close to the second end 42. For example, as shown in FIG. 4, the negative electrode of the detection power supply 141 is connected to the first end 141, the positive electrode of the detection power supply 141 is connected to a current input end of the digital unit 142, and a current output end of the digital unit 142 is connected to the second end 42. It may be understood that, in another possible implementation, the current input end of the digital unit 142 may be connected to the first end 41, the current output end of the digital unit 142 may be connected to the negative electrode of the detection power supply 141, and the positive electrode of the detection power supply 141 may be connected to the second end 42.

It can be learned from FIG. 4 that, because the detection power supply 141 can make an electric potential at the second end 42 greater than that at the first end 41, when the anti-backflow circuit 12 fails, the anti-backflow circuit 12 may transmit electric energy from an output end (connected to the second end 42) to an input end (connected to the first end 41). Therefore, a current loop may be formed between the first end 41 and the second end 42 of the detection circuit 14, and a detection current is transmitted between the first end 41 and the second end 42. FIG. 4 is used as an example. When the anti-backflow circuit 12 fails, a detection current is output from the positive electrode of the detection power supply 141, and flows back to the negative electrode of the detection power supply 141 after being successively transmitted by the digital unit 142 and the anti-backflow circuit 12.

The digital unit 142 includes a signal output end. When transmitting the detection current, the digital unit 142 may output a first level signal S1 by using the signal output end. The first level signal S1 may indicate that the anti-backflow circuit 12 fails. For example, the digital unit 142 may output a digital signal, and the digital signal mainly includes a high-level signal and a low-level signal. In this embodiment of this disclosure, the first level signal S1 may be any level signal in the digital signal. This is not limited in embodiments of this disclosure.

It may be understood that, when the anti-backflow circuit 12 does not fail, a current loop cannot be formed between the first end 41 and the second end 42. Therefore, no detection current is transmitted between the first end 41 and the second end 42. In this embodiment of this disclosure, the digital unit 142 may further output a second level signal S2 when the digital unit 142 does not transmit a detection current. The second level signal S2 may indicate that the anti-backflow circuit 12 does not fail.

The second level signal S2 may be a signal corresponding to the first level signal S1. For example, if the first level signal S1 is a high-level signal, the second level signal S2 is a low-level signal. For another example, if the first level signal S1 is a low-level signal, the second level signal S2 is a high-level signal. In other words, the digital unit 142 may output a digital signal. When the digital signal is at a first level, it may indicate that the anti-backflow circuit 12 fails; and when the digital signal is at a second level, it may indicate that the anti-backflow circuit 12 does not fail.

In conclusion, this embodiment of this disclosure provides the detection circuit 14. The detection power supply 141 and the digital unit 142 are disposed in the detection circuit 14. When the detection current is transmitted between the first end 41 and the second end 42 of the detection circuit 14, the digital unit 142 may output the first level signal to indicate that the anti-backflow circuit 12 fails. In this embodiment of this disclosure, the first level signal is generated based on the detection current. The detection circuit 14 only needs to distinguish whether there is a detection current, and does not need to further detect the detection current. Therefore, compared with the solution shown in FIG. 3, a detection result of the detection circuit 14 provided in this embodiment of this disclosure may not depend on detection precision of a voltage value. This helps improve accuracy of failure detection of the anti-backflow circuit 12.

In addition, the detection circuit 14 provided in this embodiment of this disclosure does not depend on an input voltage and an output voltage of the anti-backflow circuit 12 to perform detection. Therefore, the detection circuit 14 may perform failure detection before a charging pile 20 is connected to a power battery 30. This further helps protect safety of an electric vehicle.

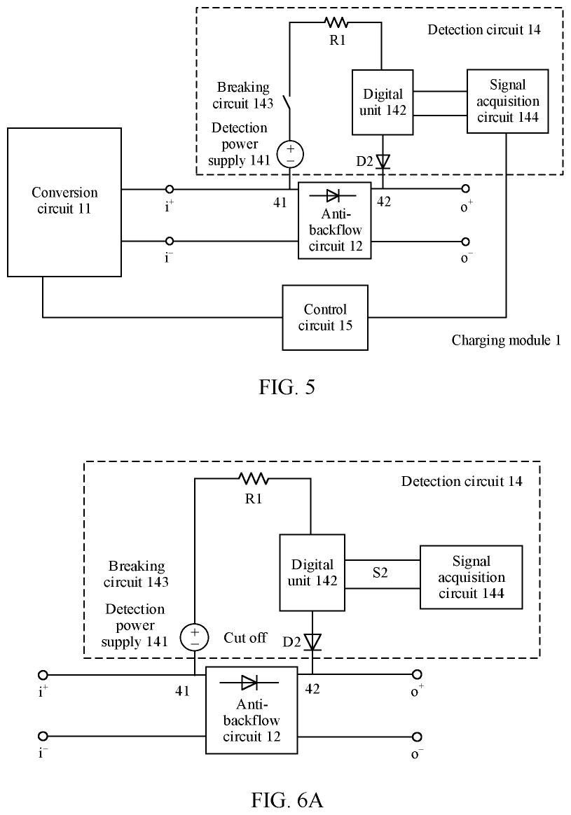

To prolong a service life of the detection circuit 14, in a possible implementation, as shown in FIG. 5, the detection circuit 14 may further include a breaking circuit 143, and the breaking circuit 143 is connected in series to both the detection power supply 141 and the digital unit 142. For example, the breaking circuit 143 may be a circuit that includes a switching element such as a relay or a switching transistor and that has a switching function. This is not limited in embodiments of this disclosure.

In a specific implementation, as shown in FIG. 5, the breaking circuit 143 is located between the detection power supply 141 and the digital unit 142, one end of the breaking circuit 143 is connected to the detection power supply 141, and the other end of the breaking circuit 143 is connected to the digital unit 142. It may be understood that, another possible structure may alternatively be connected in series between two of the breaking circuit 143, the detection power supply 141, and the digital unit 142. These are not listed in embodiments of this disclosure one by one.

In this embodiment of this disclosure, the breaking circuit 143 may be connected during failure detection of the anti-backflow circuit, so that a current loop can be formed between the first end 41 and the second end 42 of the detection circuit 14 when the anti-backflow circuit 12 fails. The breaking circuit 143 may also be disconnected after failure detection of the anti-backflow circuit 12 ends. This helps prolong the service life of the detection circuit 14.

As described above, the output end of the anti-backflow circuit 12 is connected to the power battery 30. Because the second end 42 of the detection circuit 14 is connected to the high-electric-potential output end o⁺ of the anti-backflow circuit 12, electric energy of the power battery 30 may flow back to the detection circuit 14, and the detection circuit 14 may be damaged.

In view of this, the detection circuit 14 may further include a detection diode D2. The detection diode D2 is connected in series to both the detection power supply 141 and the digital unit 142. In addition, an anode of the detection diode D2 may receive the detection current, and a cathode of the detection diode D2 may output the detection current. In other words, the detection diode D2 does not block transmission of the detection current. However, during backflow of the power battery 30 to the detection circuit 14, if the detection diode D2 is not disposed, a backflow current is input from the second end 42 of the detection circuit 14, and is output from the first end of the detection circuit 14. Therefore, in this embodiment of this disclosure, the detection diode D2 may be disposed to block transmission of the backflow current in the detection circuit 14. This helps prevent backflow of the power battery 30 to the detection circuit 14.

In a specific implementation structure, as shown in FIG. 5, the anode of the detection diode D2 is connected to the current output end of the digital unit 142, and the cathode of the detection diode D2 is connected to the second end 42. It may be understood that, another possible structure may alternatively be connected in series between two of the detection diode D2, the detection power supply 141, and the digital unit 142. These are not listed in embodiments of this disclosure one by one.

To prevent a large detection current from damaging the digital unit 142, in a possible implementation, the detection circuit 14 may further include a detection circuit R1, and the detection resistor R1 is connected in series to both the detection power supply 141 and the digital unit 142. The detection resistor R1 may perform current limiting on the detection current. This helps prevent the digital unit 142 from being damaged due to an excessively large detection current.

In a specific implementation structure, as shown in FIG. 5, one end of the detection resistor R1 is connected to the detection power supply 141 (through the breaking circuit 143), and the other end of the detection resistor R1 is connected to the current input end of the digital unit 142. It may be understood that, another possible structure may alternatively be connected in series between two of the detection resistor R1, the detection power supply 141, and the digital unit 142. These are not listed in embodiments of this disclosure one by one.

In the detection circuit 14 provided in this embodiment of this disclosure, the digital unit 142 may output a digital signal. The digital signal may be the first level signal S1 or the second level signal S2. The digital signal output by the digital unit 142 may be transmitted to a control circuit 15 (as shown in FIG. 2 and FIG. 5) of the charging module 1, and the control circuit 15 determines, based on a level of the digital signal, whether the anti-backflow circuit 12 fails.

The control circuit 15 may be a circuit having a logical operation capability, and is a control chip in the charging module 1. For example, the control circuit 15 may be a control component such as a processor, a microprocessor, or a controller. For example, the control circuit may be a general-purpose central processing unit (CPU), a general-purpose processor, digital signal processing (DSP), an application-specific integrated circuit (ASIC), a field-programmable gate array (FPGA), or another programmable logic device, a transistor logic device, a hardware component, or any combination thereof.

The control circuit 15 may control a conversion circuit 11 to perform voltage conversion. In this embodiment of this disclosure, the control circuit 15 may make the breaking circuit 143 connected before the conversion circuit 11 outputs direct current electric power, so that failure detection can be performed on the anti-backflow circuit 12 by using the detection circuit 14.

In a failure detection process, if the control circuit 15 receives the first level signal S1, it indicates that the anti-backflow circuit 12 fails. In this case, the control circuit 15 may prohibit the conversion circuit 11 from outputting the direct current electric power. The control circuit 15 may further control the charging module 1 to send alarm information, to provide maintenance information for management personnel. If the control circuit 15 receives the second level signal S2, it indicates that the anti-backflow circuit 12 does not fail in this case. In this case, the control circuit 15 may control the conversion circuit 11 to start to output the direct current electric power.

Generally, the control circuit 15 is a digital circuit, and may process a digital signal. However, a level signal output by the digital unit 142 may be difficult to be identified by the control circuit 15 due to an irregular waveform. In view of this, as shown in FIG. 5, the detection circuit 14 may further include a signal acquisition circuit 144. The signal acquisition circuit 144 is connected to the signal output end of the digital unit 142. The signal acquisition circuit 144 may perform shaping filtering on the first level signal S1 or the second level signal S2 output by the digital unit 142. After shaping filtering is performed, a waveform of a digital signal output by the digital unit 142 is more regular, so that the control circuit 15 can identify the first level signal S1 or the second level signal S2 more accurately.

Next, the detection circuit 14 shown in FIG. 5 is used as an example. Failure detection processes in a scenario in which the anti-backflow circuit 12 fails and a scenario in which the anti-backflow circuit 12 does not fail are further described by using examples.

Scenario 1: The anti-backflow circuit 12 does not fail.

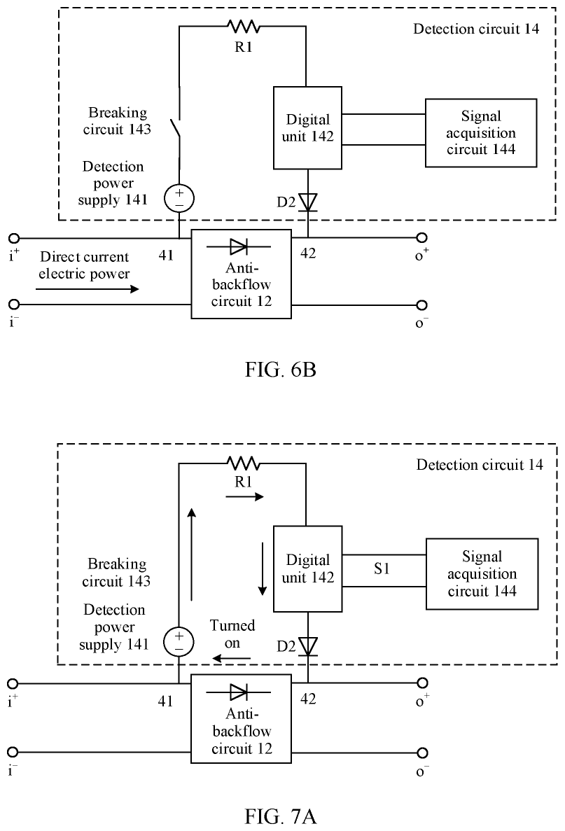

As shown in FIG. 6A, during failure detection of the anti-backflow circuit 12, the breaking circuit 143 is connected. The detection power supply 141 may apply bias voltages to the first end 41 and the second end 42 to make an electric potential at the second end 42 higher than that at the first end 41. When the anti-backflow circuit 12 does not fail, the anti-backflow circuit 12 cannot transmit electric energy from the output end to the input end. In other words, because the electric potential at the second end 42 is higher than that at the first end 41, when the anti-backflow circuit 12 does not fail, the anti-backflow circuit 12 is cut off in a direction from the second end 42 to the first end 41. In this way, a current loop cannot be formed between the first end 41 and the second end 42, and no detection current is transmitted in the digital unit 142. Therefore, the digital unit 142 may output a second level signal S2.

After performing shaping filtering on the second level signal S2, the signal acquisition circuit 144 further transmits the second level signal S2 to the control circuit 15. As shown in FIG. 6B, after receiving the second level signal S2, the control circuit 15 may make the breaking circuit 143 disconnected, and control the conversion circuit 11 to output direct current electric power. After being transmitted by the anti-backflow circuit 12, the direct current electric power is output to the charging pile 20.

Scenario 2: The anti-backflow circuit 12 fails.

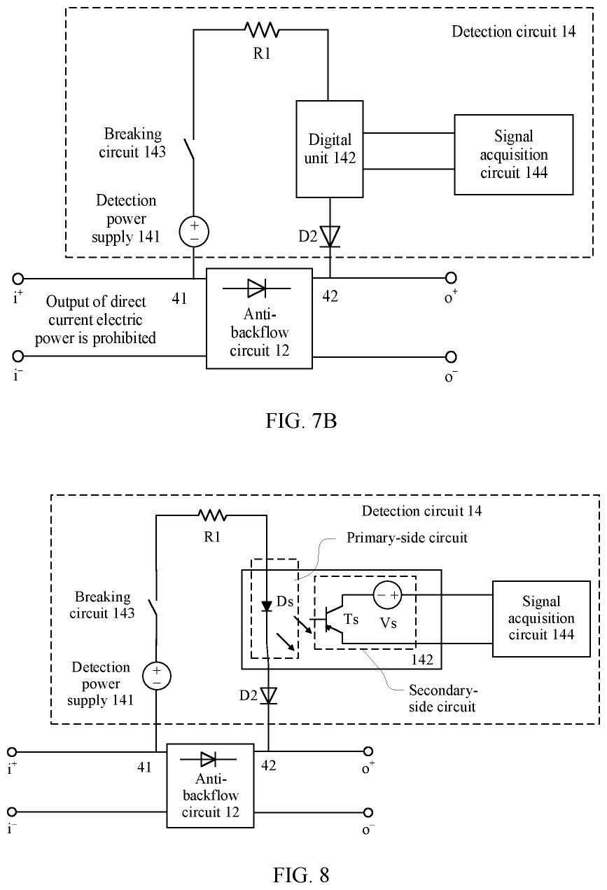

As shown in FIG. 7A, during failure detection of the anti-backflow circuit 12, the breaking circuit 143 is connected. The detection power supply 141 may apply bias voltages to the first end 41 and the second end 42 to make an electric potential at the second end 42 higher than that at the first end 41. When the anti-backflow circuit 12 fails, the anti-backflow circuit 12 may transmit electric energy from the output end to the input end. In other words, because the electric potential at the second end 42 is higher than that at the first end 41, when the anti-backflow circuit 12 fails, the anti-backflow circuit 12 is connected in a direction from the second end 42 to the first end 41. In this way, a current loop can be formed between the first end 41 and the second end 42.

As shown by an arrow in FIG. 7A, a detection current may be output from the positive electrode of the detection power supply 141, and is input to the output end of the anti-backflow circuit 12 from the second end 42 after being successively transmitted by the breaking circuit 143, the detection resistor R1, the digital unit 142, and the detection diode D2. Because the anti-backflow circuit 12 fails, in the anti-backflow circuit 12, the detection current is transmitted from the output end of the anti-backflow circuit 12 to the input end of the anti-backflow circuit 12, and then is input to the detection circuit 14 from the first end 41, to flow back to the negative electrode of the detection power supply 141. Therefore, when the anti-backflow circuit 12 fails, a current loop for transmitting the detection current may be formed between the first end 41 and the second end 42.

In this case, the detection current is transmitted through the digital unit 142. When transmitting the detection current, the digital unit 142 may output a first level signal S1.

After performing shaping filtering on the first level signal S1, the signal acquisition circuit 144 further transmits the first level signal S1 to the control circuit 15. As shown in FIG. 7B, after receiving the first level signal S1, the control circuit 15 may make the breaking circuit 143 disconnected, and forbid the conversion circuit 11 from outputting direct current electric power.

The foregoing uses the examples to describe the failure detection processes to which the detection circuit 14 provided in this embodiment of this disclosure is applicable. It can be learned from the foregoing examples that, the digital unit 142 in this embodiment of this disclosure may output the first level signal S1 when transmitting the detection current, and output the second level signal S2 when the digital unit 142 does not transmit a detection current.

In a possible implementation, the digital unit 142 provided in this embodiment of this disclosure may further use an isolation structure to enhance anti-EMI performance of the charging module 1. As described above, the conversion circuit 11 may further include an EMI filter circuit. The EMI filter circuit may filter out EMI in direct current electric power output by the conversion circuit 11. However, as shown in FIG. 5, the control circuit 15 is connected to both the conversion circuit 11 and the digital unit 142, and some EMI is directly output from the charging module 1 after being transmitted through the control circuit 15, the digital unit 142, and the detection diode D2. The EMI bypasses the EMI filter circuit. In this case, there is EMI in direct current electric power output by the charging module 1. This is not conducive to improvement of anti-EMI performance of the charging module 1.

In view of this, in this embodiment of this disclosure, the digital unit 142 may use an isolation structure to block a path used for transmitting EMI through the digital unit 142. For example, the digital unit 142 may include a primary-side circuit and a secondary-side circuit, and the primary-side circuit and the secondary-side circuit are isolated from each other. The isolation means that a current cannot be directly transmitted between the primary-side circuit and the secondary-side circuit. This helps suppress EMI from being directly output from the charging module 1 through the control circuit 15 and the detection circuit 14. The primary-side circuit may transmit the detection current, and the secondary-side circuit may output the first level signal when the primary-side circuit transmits the detection current. When the primary-side circuit does not transmit a detection current, the secondary-side circuit may also output the second level signal.

For example, although the primary-side circuit and the secondary-side circuit are isolated from each other, coupling in a form of an energy field, for example, optical coupling, magnetic coupling, or electric field coupling, may be implemented between the primary-side circuit and the secondary-side circuit. When the detection current passes through the primary-side circuit, the secondary-side circuit may sense an energy change in the primary-side circuit by using an energy field, to generate the first level signal.

In a specific example, the primary-side circuit and the secondary-side circuit are optically coupled, and the isolation between the primary-side circuit and the secondary-side circuit may also be referred to as optical isolation. As shown in FIG. 8, the primary-side circuit includes a light-emitting diode Ds, an anode of the light-emitting diode Ds may receive the detection current, a cathode of the light-emitting diode Ds may output the detection current, and the light-emitting diode Ds may emit light when transmitting the detection current.

In other words, the anode of the light-emitting diode Ds may be used as the current input end of the digital unit 142, and the cathode of the light-emitting diode Ds may be used as the current output end of the digital unit 142. When a detection current is transmitted in the detection circuit 14, the light-emitting diode Ds may be kept on.

In FIG. 8, the anode of the light-emitting diode Ds is connected to the detection resistor R1, and the cathode of the light-emitting diode Ds is connected to the anode of the detection diode D2. It may be understood that, FIG. 8 is merely a specific example, and another structure may alternatively be connected in series between the light-emitting diode Ds and another element in the detection circuit 14. These are not listed in embodiments of this disclosure one by one.

The secondary-side circuit includes a light-sensing switching transistor Ts, and the light-sensing switching transistor may sense a light-emitting status of the light-emitting diode Ds. When the light-emitting diode Ts emits light, the light-sensing switching transistor Ts is turned on, so that the secondary-side circuit outputs the first level signal. In a specific example, the secondary-side circuit may further include a signal source Vs, and the signal source Vs may be a stable direct current power supply. When the light-sensing switching transistor Ts is turned on, the signal source Vs may output the first level signal. In this case, the first level signal is a high level. When the light-sensing switching transistor Ts is turned off, that is, when the light-emitting diode Ds does not transmit a detection current, the signal source Vs stops outputting the first level signal, and a level of a digital signal output by the secondary-side circuit is reduced to a low level. An obtained signal is the second level signal.

It may be understood that, the isolation between the primary-side circuit and the secondary-side circuit may alternatively be magnetic isolation. To be specific, magnetic coupling is implemented between the primary-side circuit and the secondary-side circuit. The isolation between the primary-side circuit and the secondary-side circuit may alternatively be capacitive isolation. To be specific, the primary-side circuit and the secondary-side circuit are coupled by using a capacitive electric field. Both magnetic isolation and capacitive isolation have mature applications in a signal isolation transmission chip. Details are not described in embodiments of this disclosure.

Obviously, a person skilled in the art can make various modifications and variations to this disclosure without departing from the protection scope of this disclosure. Thus, if these modifications and variations of this disclosure fall within the scope of the claims of this disclosure and equivalent technologies thereof, this disclosure is also intended to include these modifications and variations.

What is claimed is:

1. An apparatus, comprising:
a first end configured to be connected to a high-electric-potential input end of an anti-backflow circuit;
a second end configured to be connected to a high-electric-potential output end of the anti-backflow circuit;
a detection power supply connected to the first end;
a digital component connected to the second end; and
a detection power supply connected to the first end and the digital component, wherein the detection power supply and the digital component are connected in series between the first end and the second end, and wherein the detection power supply is configured to:
apply bias voltages to the first end and the second end to make a first electric potential at the second end higher than a second electric potential at the first end;
transmit a detection current between the first end and the second end when a current loop is formed between the first end and the second end; and
output a first level signal when transmitting the detection current,
wherein the first level signal indicates that the anti-backflow circuit has failed.

2. The apparatus of claim 1, wherein the digital component is further configured to output a second level signal when the digital component does not transmit the detection current, and wherein the second level signal indicates that the anti-backflow circuit has not failed.

3. The apparatus of claim 1, wherein the detection power supply comprises:
a positive electrode; and
a negative electrode connected to the first end, and
wherein the digital component comprises:
a current input end connected to the positive electrode;
a current output end connected to the second end; and
a signal output end configured to output the first level signal.

4. The apparatus of claim 1, further comprising a breaking circuit connected in series to both the detection power supply and the digital component, wherein the breaking circuit is configured to:
electrically connect the detection power supply and the digital component during failure detection of the anti-backflow circuit; and
electrically disconnect the detection power supply and the digital component when the failure detection ends.

5. The apparatus of claim 1, further comprising a detection diode connected in series to both the detection power supply and the digital component, wherein the detection diode comprises:
an anode configured to receive the detection current; and
a cathode configured to output the detection current.

6. The apparatus of claim 1, further comprising a detection resistor connected in series to both the detection power supply and the digital component.

7. The apparatus of claim 1, wherein the digital component comprises:
a primary-side circuit configured to transmit the detection current; and
a secondary-side circuit configured to output the first level signal when the primary circuit transmits the detection current, and
wherein the secondary-side circuit and the primary-side circuit are isolated from each other.

8. The apparatus of claim 7, wherein the primary-side circuit comprises a light-emitting diode comprising:
an anode configured to receive the detection current; and
a cathode configured to output the detection current,
wherein the light-emitting diode is configured to emit light when transmitting the detection current,
wherein the secondary-side circuit comprises a light-sensing switching transistor configured to be turned on when the light-emitting diode emits light, and
wherein the secondary-side circuit outputs the first level signal when the light-sensing switching transistor is turned on.

9. The apparatus of claim 1, further comprising a signal acquisition circuit configured to perform shaping filtering on the first level signal.

10. A system, comprising:
an anti-backflow circuit comprising:
a high-electric-potential input end; and
a high-electric-potential output end; and
a detection circuit configured to perform failure detection on the anti-backflow circuit and comprising:
a first end configured to be connected to the high-electric-potential input end;
a second end configured to be connected to the high-electric-potential output end;
a detection power supply connected to the first end;
a digital component connected to the second end; and
a detection power supply connected to the first end and the digital component, wherein the detection power supply and the digital component are connected in series between the first end and the second end, and wherein the detection power supply is configured to:
apply bias voltages to the first end and the second end to make a first electric potential at the second end higher than a second electric potential at the first end;
transmit a detection current between the first end and the second end when a current loop is formed between the first end and the second end; and
output a first level signal when transmitting the detection current,
wherein the first level signal indicates that the anti-backflow circuit has failed.

11. The system of claim 10, wherein the digital component is further configured to output a second level signal when the digital component does not transmit the detection current, and wherein the second level signal indicates that the anti-backflow circuit has not failed.

12. The system of claim 10, wherein the detection power supply comprises:
a positive electrode; and
a negative electrode connected to the first end, and
wherein the digital component comprises:
a current input end connected to the positive electrode;
a current output end connected to the second end; and
a signal output end configured to output the first level signal.

13. The system of claim 10, wherein the detection circuit further comprises a breaking circuit connected in series to both the detection power supply and the digital component, and wherein the breaking circuit is configured to:
electrically connect the detection power supply and the digital component during failure detection of the anti-backflow circuit; and
electrically disconnect the detection power supply and the digital component when the failure detection ends.

14. The system of claim 10, wherein the detection circuit further comprises a detection diode connected in series to both the detection power supply and the digital component, and wherein the detection diode comprises:
an anode configured to receive the detection current; and
a cathode configured to output the detection current.

15. The system of claim 10, wherein the detection circuit further comprises a detection resistor connected in series to both the detection power supply and the digital component.

16. The system of claim 10, wherein the digital component comprises:
a primary-side circuit configured to transmit the detection current; and
a secondary-side circuit configured to output the first level signal when the primary circuit transmits the detection current, and
wherein the secondary-side circuit and the primary-side circuit are isolated from each other.

17. The system of claim 16, wherein the primary-side circuit comprises a light-emitting diode comprising:
an anode configured to receive the detection current; and
a cathode configured to output the detection current,
wherein the light-emitting diode is configured to emit light when transmitting the detection current,
wherein the secondary-side circuit comprises a light-sensing switching transistor configured to be turned on when the light-emitting diode emits light, and
wherein the secondary-side circuit outputs the first level signal when the light-sensing switching transistor is turned on.

18. The system of claim 10, wherein the detection circuit further comprises a signal acquisition circuit configured to perform shaping filtering on the first level signal.

19. An apparatus, comprising:
a conversion circuit configured to:
receive alternating current electric power;
convert the alternating current electric power into direct current electric power; and
output the direct current electric power; and
an anti-backflow system configured to:
receive the direct current electric power from the conversion circuit; and
output the direct current electric power to a battery,
wherein the anti-backflow system comprises:
an anti-backflow circuit comprising:
a high-electric-potential input end; and
a high-electric-potential output end; and
a detection circuit configured to perform failure detection on the anti-backflow circuit and comprising:
a first end configured to be connected to the high-electric-potential input end;
a second end configured to be connected to the high-electric-potential output end;
a detection power supply connected to the first end;
a digital component connected to the second end,
a detection power supply connected to the first end and the digital component, wherein the detection power supply and the digital component are connected in series between the first end and the second end, and wherein the detection power supply is configured to:
apply bias voltages to the first end and the second end to make a first electric potential at the second end higher than a second electric potential at the first end;
transmit a detection current between the first end and the second end when a current loop is formed between the first end and the second end; and
output a first level signal when transmitting the detection current,
wherein the first level signal indicates that the anti-backflow circuit has failed.

20. The apparatus of claim 19, further comprising a control circuit connected to both the conversion circuit and the digital component and configured to receive the first level signal, wherein after receiving the first level signal, the control circuit is configured to prohibit the conversion circuit from outputting the direct current electric power.
